(19) United States
(12) Patent Application Publication
(10) Pub. No.: US 2007/0120897 A1
(43) Pub. Date: May 31, 2007

(54) MICROINJECTORS

(75) Inventor: Chung Cheng Chou, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/563,130

(22) Filed: Nov. 24, 2006

(30) Foreign Application Priority Data
Nov. 30, 2005 (TW) TW94142043

(51) Int. Cl. B41J 2/045

(52) U.S. Cl. 347/68

(57) ABSTRACT

Microinjectors are provided. A microinjector includes a substrate, a channel, a nozzle formed at an end of the channel, and a deformable mechanism disposed on the substrate. A droplet is generated by ejecting fluid through the nozzle. The deformable mechanism comprises a piezoelectric layer and a flexible member. The flexible member connects the piezoelectric layer and the substrate, defining a part of the channel. When an electrical field is applied to the piezoelectric layer, the flexible member and the piezoelectric layer are deformed, altering profile of the channel.

### BACKGROUND OF THE INVENTION

1. Field of the Invention

The invention relates in general to microinjectors and in particular to microinjectors controlling droplet ejection direction.

2. Description of the Related Art

With progress of micromachining technologies, thermal bubble and piezoelectric actuations have been applied in microinjectors. Referring to FIG. 1, a conventional microinjector mechanism of an inkjet printer of EP 1116586 A1 primarily includes a thermally-actuated paddle 2, a front substrate 3, a back substrate 4, and a heater 30. The front and back substrates 3 and 4 form a channel with ink received therein, and a ink droplet D is ejected through the nozzle 3′ by the paddle 2. Ejection of the droplet D is enhanced by the heater 30 disposed adjacent to the nozzle 3′. Another conventional inkjet printer, according to U.S. Pat. No. 6,536,882 B1, controls droplet ejection direction by a heater surrounding the nozzle outlet circumference.

### BRIEF SUMMARY OF THE INVENTION

Microinjectors are provided. An embodiment of a microinjector includes a substrate, a channel, a nozzle formed at an end of the channel, and a deformable mechanism disposed on the substrate. A droplet is generated by ejecting fluid through the nozzle. The deformable mechanism comprises a piezoelectric layer and a flexible member. The flexible member connects the piezoelectric layer and the substrate, defining a part of the channel. When an electrical field is applied to the piezoelectric layer, the flexible member and the piezoelectric layer are deformed, altering the profile of the channel.

### BRIEF DESCRIPTION OF THE DRAWINGS

The invention can be more fully understood by reading the subsequent detailed description and examples with references made to the accompanying drawings, wherein:

FIG. 1 is a perspective diagram of a conventional microinjector of an inkjet printer;

FIG. 2 is a top view of an embodiment of a microinjector;

FIG. 3 is a sectional view of FIG. 2 along C-C′;

FIGS. 4a, 4b, 5a, and 5b are perspective diagrams of the microinjector in FIG. 3 when a piezoelectric layer thereof deforms;

FIGS. 6a and 6b are perspective diagrams of a microinjector comprising two nozzles;

FIGS. 7a-7f are perspective diagrams of a microinjector comprising two piezoelectric layers and two deformable members;

FIG. 8 is a perspective diagram of a microinjector comprising a plurality of piezoelectric layers and deformable members;

FIG. 9 is a perspective diagram of a microinjector comprising a plurality of embedded piezoelectric portions; and

FIGS. 10a and 10b are perspective diagrams of a microinjector comprising round nozzles.

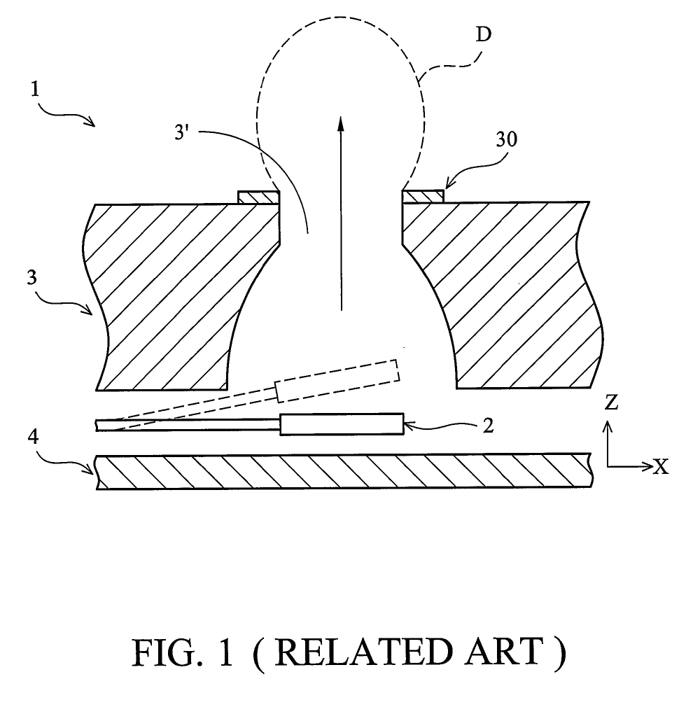

### DETAILED DESCRIPTION OF THE INVENTION

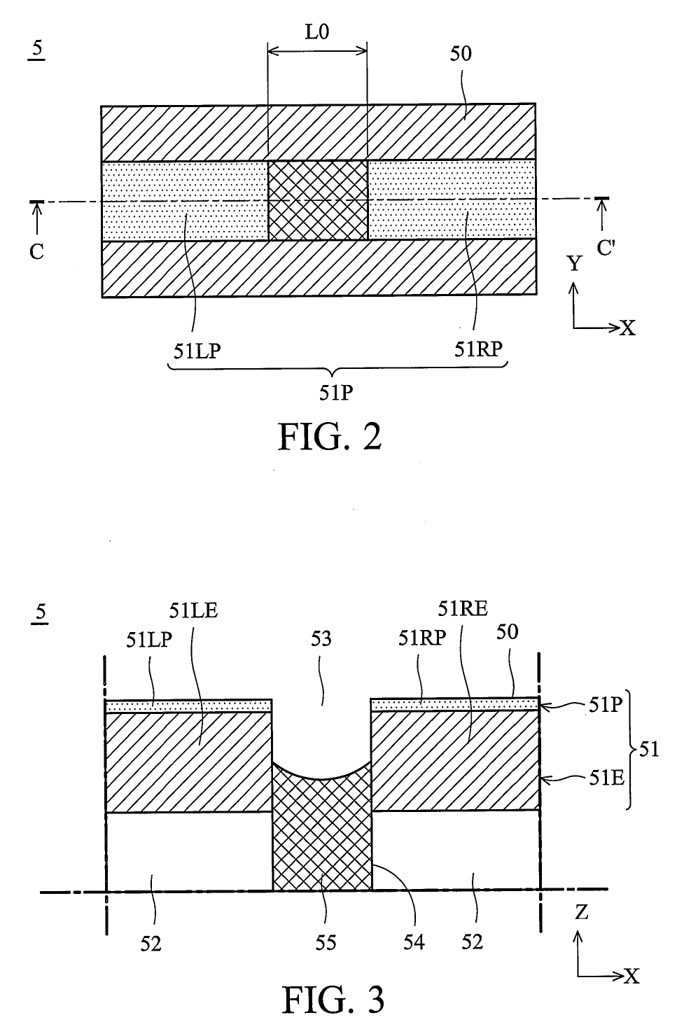

Referring to FIG. 2, an embodiment of a microinjector 5 comprises a piezoelectric layer 51P disposed on an outer surface 50 thereof. The piezoelectric layer 51P includes two piezoelectric portions 51RP and 51LP with a nozzle 53 formed therebetweeen. As shown in FIG. 2, the nozzle 53 has a width L0 along X axis. Fluid can be ejected through the nozzle 53 by an actuator adjacent to the nozzle 53, such as a heater (not shown).

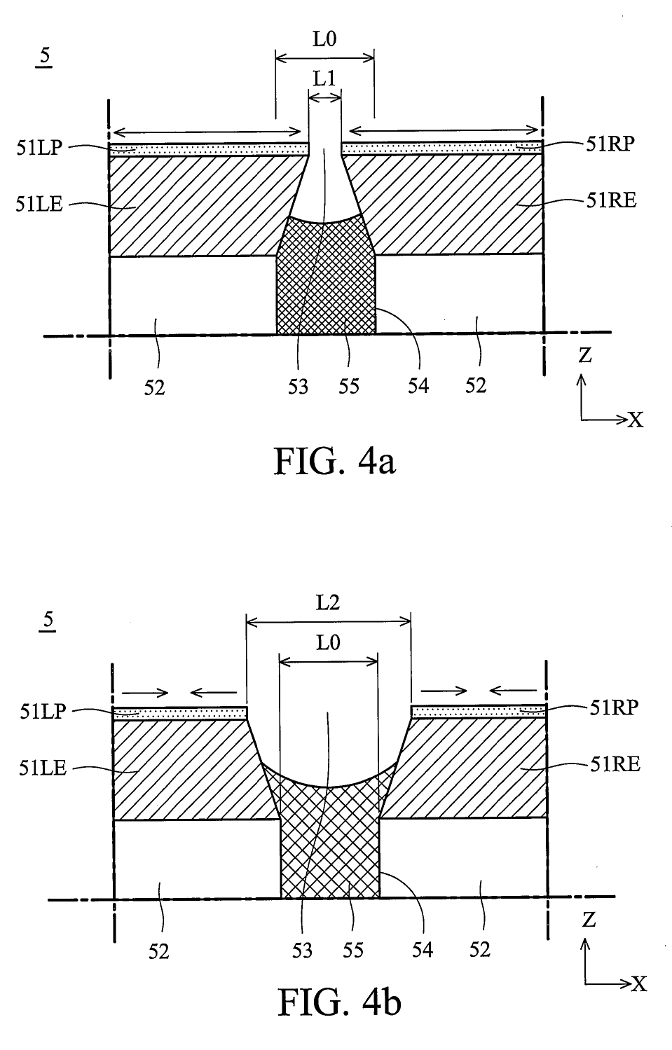

Referring to FIG. 3, the microinjector 5 includes a substrate 52 and a deformable mechanism 51 disposed thereon. Here, the deformable mechanism 51 comprises a flexible member 51E and the piezoelectric layer 51P. The piezoelectric layer 51P may comprise lead zirconate titanate (PZT), and the flexible member 51E may comprise polymer composite, including a first flexible portion 51RE and a second flexible portion 51LE. As shown in FIG. 3, a channel 54 is connected to the nozzle 53 through the substrate 52 and the flexible member 51E along Z axis, wherein fluid 55 in the channel 54 can be ejected from the nozzle 53.

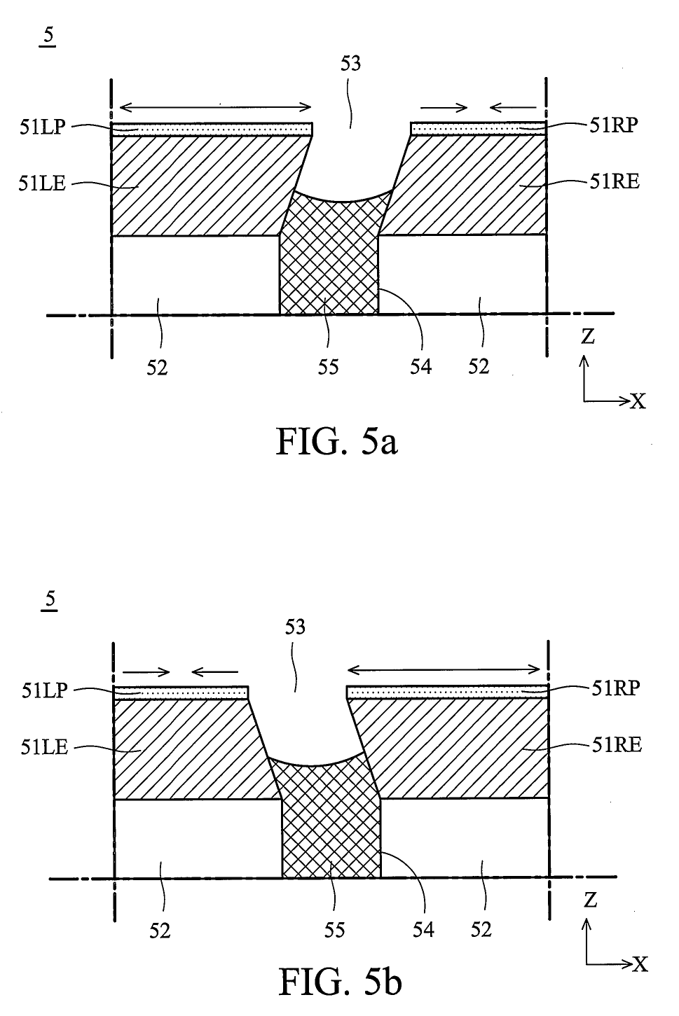

In this embodiment, the piezoelectric portions 51RP and 51LP are coated with electrodes on top and bottom surfaces thereof. When an electrical field is applied to the piezoelectric layer 51P along Z axis per top and bottom electrodes, the piezoelectric portions 51RP and 51LP can contract or expand along X axis, and the first and second flexible portions 51RE and 51LE are deformed, to alter profile of the nozzle 53 or the channel 54. As shown in FIG. 4a, when the piezoelectric portions 51RP and 51LP are expanded by an electrical field, the first and second flexible portions 51RE and 51LE are deformed, such that the nozzle 53 is narrowed from the width L0 to L1, reducing discharge quantity of fluid 55 and increasing ejection speed of droplets.

Alternatively, as shown in FIG. 4b, when the piezoelectric portions 51RP and 51LP contract by an inverse electrical field, the first and second flexible portions 51RE and 51LE are deformed, such that the nozzle 53 is broadened from the width L0 to L2, increasing discharge quantity of fluid 55 and reducing ejection speed of the droplets.

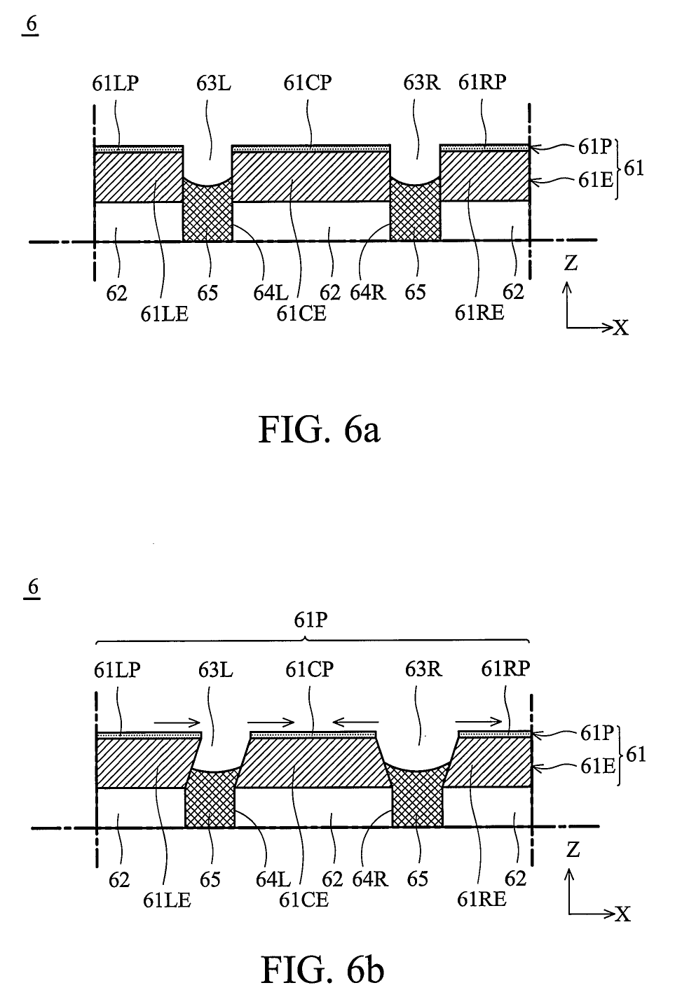

Referring to FIG. 5a, when the piezoelectric portion 51RP contracts and the piezoelectric portion 51LP expands by two opposite electrical fields, the channel 54 between the first and second flexible portions 51RE and 51LE is deflected to the right. Similarly, as shown in FIG. 5b, the channel 54 is deflected to the left when the piezoelectric portion 51RP expands and the piezoelectric portion 51LP contracts. According to this embodiment, profiles of the channel 54 can be appropriately altered to achieve deflected ejection of the droplet, wherein width of the nozzle 53 can remain the same by complementary deformations of the piezoelectric portions 51RP and 51LP.

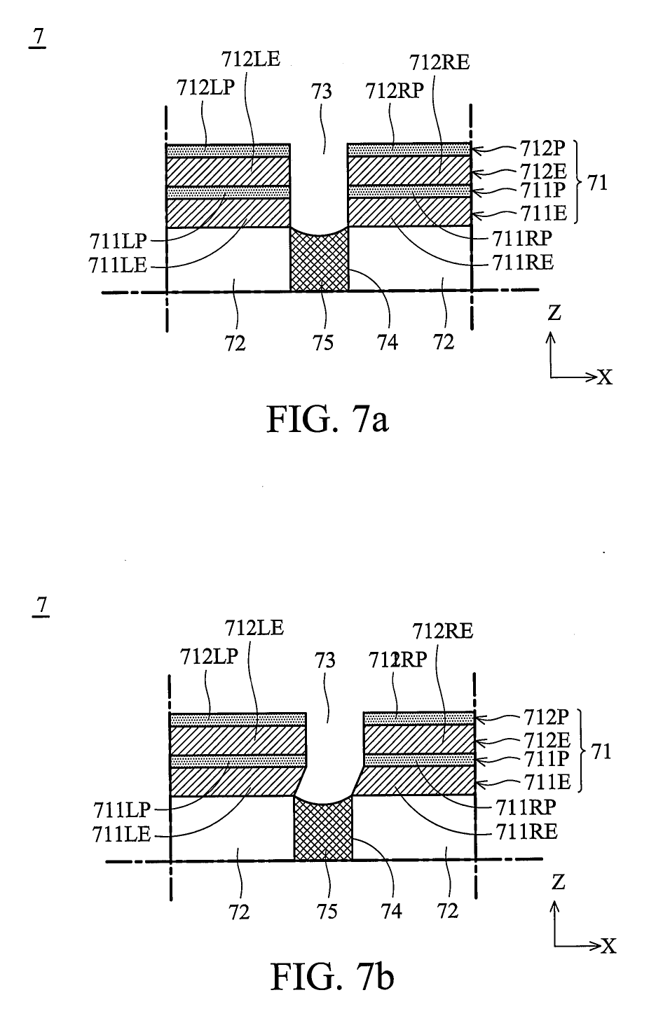

Referring to FIG. 6a, another embodiment of a microinjector 6 primarily includes a substrate 62, a deformable mechanism 61 disposed on the substrate 62, two channels 64L and 64R through the deformable mechanism 61 and the substrate 62, and two nozzles 63L and 63R connected to the channels 64L and 64R, respectively. As shown in FIG. 6a, the deformable mechanism 61 comprises a flexible member 61E and a piezoelectric layer 61P disposed thereon. In this embodiment, the piezoelectric layer 61P includes three piezoelectric portions 61RP, 61LP, and 61CP coated with electrodes. The flexible member 61E includes three flexible portions 61RE, 61LE, and 61CE respectively connected to the piezoelectric portions 61RP, 61LP, and 61CP. Profiles of the nozzles 63L and 63R and the channels 64L and 64R can be appropriately altered by expansion or contraction of the piezoelectric portions 61RP, 61LP, and 61CP along X axis when an electrical field is applied thereto along Z axis.

Referring to FIG. 6b, when the piezoelectric portions 61RP and 61CP contract along X axis, the flexible portions 61 RE and 61 CE are deformed, such that the nozzle 63R is broadened, increasing discharge quantity of fluid 65 through the nozzle 63R and reducing ejection speed of droplets. Similarly, due to expansion of the piezoelectric portion 61LP and contraction of the piezoelectric portion 61CP, the channel 64L is deflected rightward to alter ejection direction of droplet through the nozzle 63L. According to this embodiment, ejection direction, speed and quantity of droplets through different nozzles can be appropriately controlled by altering profile of the deformable mechanism.

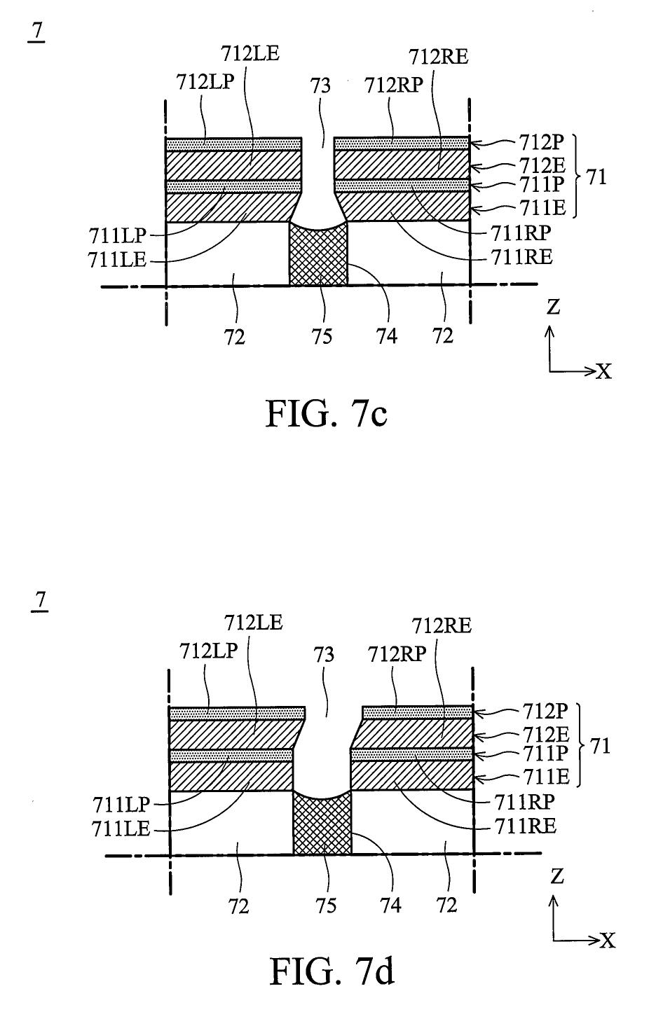

Referring to FIG. 7a, another embodiment of a microinjector 7 comprises a substrate 72, a deformable mechanism 71 disposed on the substrate 72, a channel 74, and a nozzle 73 connected to the channel 74. Specifically, the deformable mechanism 71 includes a first piezoelectric layer 711P, a second piezoelectric layer 712P, a first flexible member 711E, and a second flexible member 712E.

As shown in FIG. 7a, the first piezoelectric layer 711P comprises two piezoelectric portions 711RP and 711LP, the second piezoelectric layer 712P comprises two piezoelectric portions 712RP and 712LP, the first flexible member 711E comprises two flexible portions 711RE and 711LE, and the second flexible member 712E comprises two flexible portions 712RE and 712LE. In this embodiment, the first and second piezoelectric layers 711P and 712P are coated with electrodes on top and bottom surfaces thereof, expandable and contractible along X axis when an electrical field along Z axis is applied thereto.

Referring to FIG. 7b, when the piezoelectric portion 711RP contracts and the piezoelectric portion 711LP expands, the middle part of the channel 74 is deflected to the right, such that the second flexible member 712E, the second piezoelectric layer 712P and the nozzle 73 shift rightward along X axis. Similarly, as shown in FIG. 7c, when the piezoelectric portions 711RP and 711LP both expand along X axis, the nozzle 73 is narrowed.

Referring to FIGS. 7d and 7e, profiles of the nozzle 73 and the channel 74 can be altered when only the second piezoelectric layer 712P deforms. In FIG. 7d, when the piezoelectric portion 712LP expands and the piezoelectric portion 712RP contracts, a part of the channel 74 is deflected to the right. In FIG. 7e, the nozzle 73 is narrowed when the piezoelectric portions 712RP and 712LP both expand.

Referring to FIG. 7f, when applying electrical fields to the piezoelectric portion 711RP, 711LP, 712RP, and 712LP respectively, the nozzle 73 and the channel 74 can be deformed to a desired shape. Here, the piezoelectric portion 711RP contracts, and the piezoelectric portions 711LP, 712RP, and 712LP expand, such that the channel 74 is deflected to the right, and nozzle 73 is narrowed and shifted rightward. In this embodiment, the deformable mechanism 71 has two piezoelectric layers 711P and 712P and two flexible members 711E and 712E, such that profiles of the nozzle 73 and the channel 74 is highly alterable, facilitating control of ejection direction, speed and quantity of droplet.

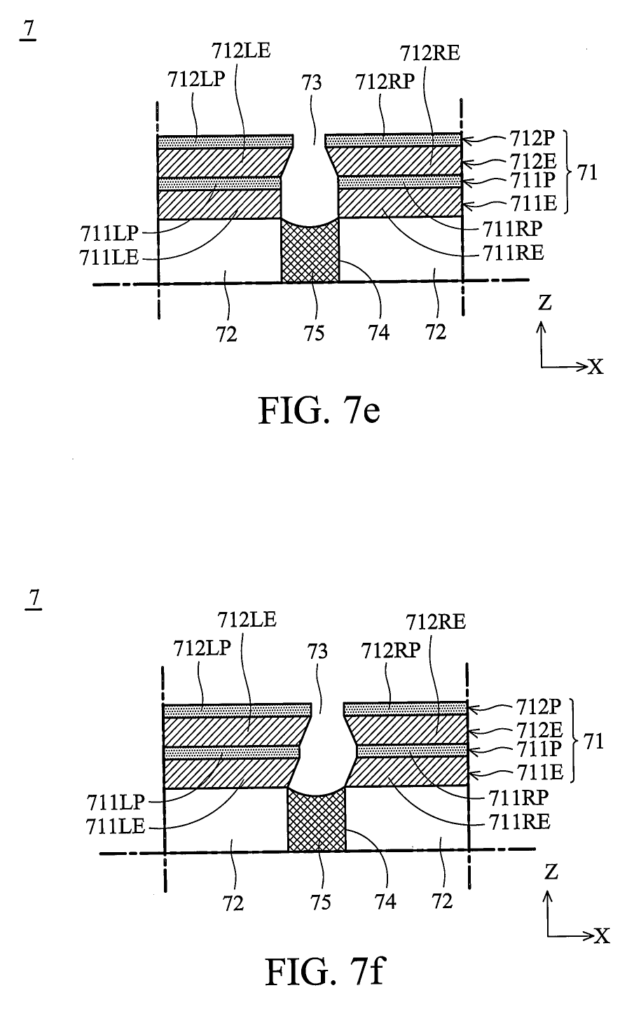

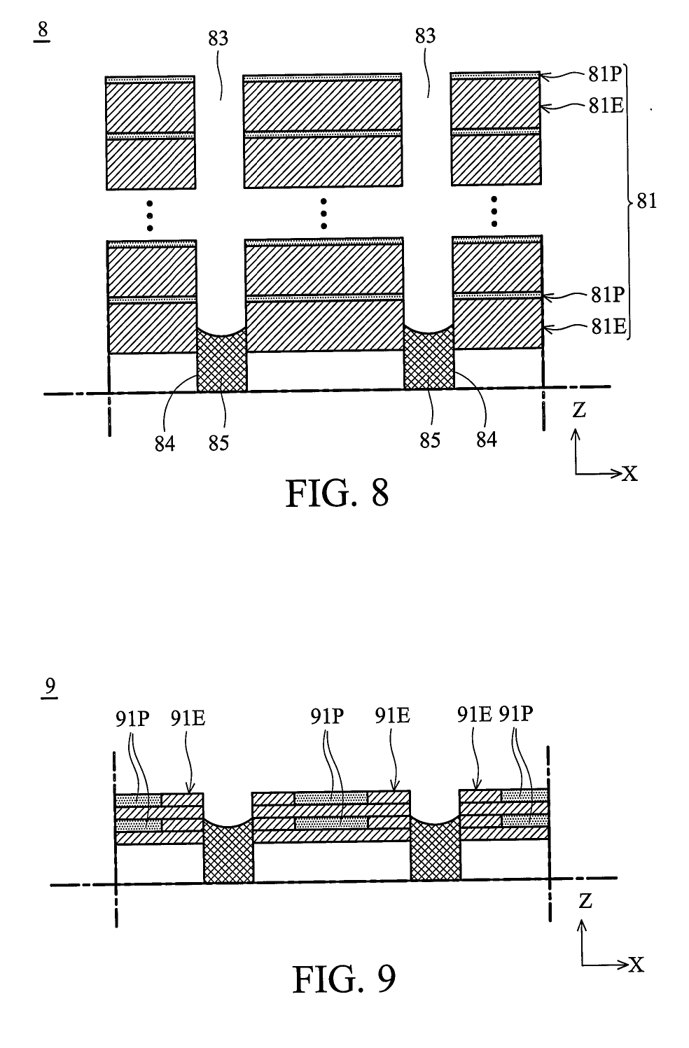

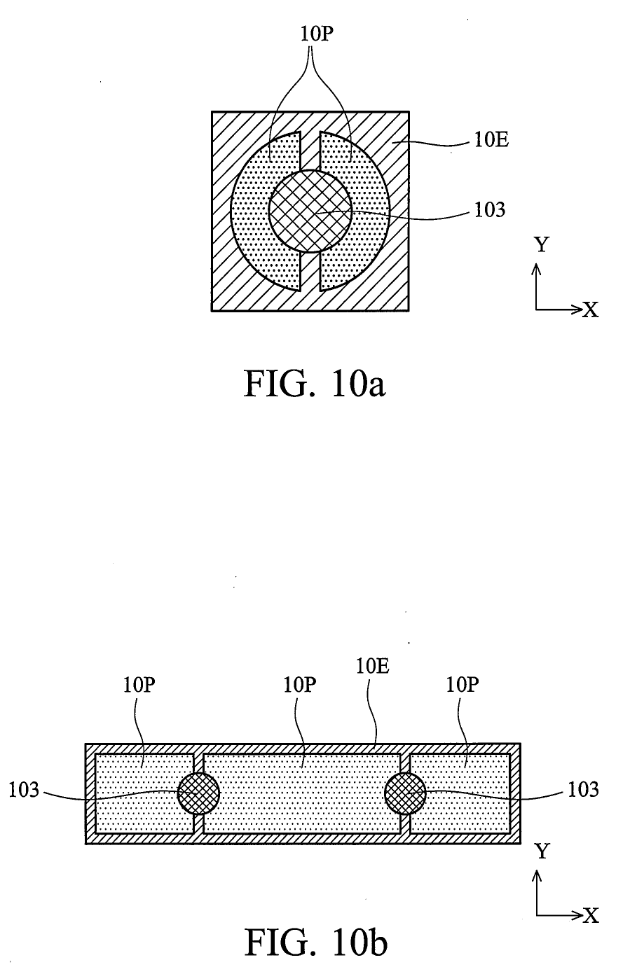

As shown in FIG. 8, another embodiment of a microinjector 8 comprises a deformable mechanism 81 including a plurality of piezoelectric layers 81P and flexible members 81E alternatively stacked along Z axis, enhancing flexibility thereof. As shown in FIG. 9, another embodiment of a microinjector 9 comprises a flexible member 91E and a plurality of piezoelectric portions 91P embedded in the flexible member 91E. As shown in FIGS. 10a and 10b, another embodiment of a microinjector comprises a plurality of round nozzles 103 formed between the piezoelectric portions 10P disposed on the flexible member 10E, rather than the rectangular nozzle 53 in FIG. 2.

Microinjectors having deformable mechanisms are provided according to the embodiments. Rather than conventional heating elements, ejection direction, speed and quantity of droplet are controlled by altering profiles of the nozzles and the channels, suitable for inkjet printers, biotechnologies, and micro jet propulsion systems.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A microinjector, comprising:
a substrate;
a channel, substantially extending along a first axis;
a nozzle, formed at an end of the channel, wherein a droplet is generated by ejecting fluid through the nozzle; and
a deformable mechanism, comprising a first piezoelectric layer and a first flexible member connecting the first piezoelectric layer and the substrate, wherein the first flexible member defines a part of the channel, and when an electrical field is applied to the first piezoelectric layer, the first flexible member and the first piezoelectric layer are deformed, to alter profile of the channel.

2. The microinjector as claimed in claim 1, wherein the first piezoelectric layer comprises a first piezoelectric portion and a second piezoelectric portion with the nozzle formed there between, wherein the nozzle is narrowed when the first and second piezoelectric portions expand, and the nozzle is broadened when the first and second piezoelectric portions contract.

3. The microinjector as claimed in claim 2, wherein the first flexible member comprises a first flexible portion and a second flexible portion respectively connecting the first and second piezoelectric layers, wherein the channel is deflected with respect to the first axis when the first piezoelectric portion expands and the second piezoelectric portion contracts, to alter ejection direction of the droplet.

4. The microinjector as claimed in claim 3, wherein the first piezoelectric layer is substantially parallel to a second axis, and the nozzle is shifted along the second axis when the channel is deflected with respect to the first axis.

5. The microinjector as claimed in claim 1, wherein the first piezoelectric layer is substantially perpendicular to the first axis and the electrical field.

6. The microinjector as claimed in claim 1, wherein the first piezoelectric layer and the electrical field are substantially perpendicular to the first axis.

7. The microinjector as claimed in claim 1, wherein the first piezoelectric layer is embedded in the first flexible member.

8. The microinjector as claimed in claim 1, wherein the first piezoelectric layer comprises lead zirconate titanate (PZT).

9. The microinjector as claimed in claim 1, wherein the flexible member comprises polymer.

10. The microinjector as claimed in claim 3, further comprising two channels and two nozzles respectively connecting the channels, the first piezoelectric layer further comprising a third piezoelectric portion, the first flexible member further comprising a third flexible portion connecting the third piezoelectric portion, wherein the nozzles are formed between the first, second and third piezoelectric layers, and the channels are formed between the first, second and third flexible portions.

11. A microinjector, comprising:
a substrate;
a channel, substantially extending along a first axis;
a nozzle, formed at an end of the channel, wherein a droplet is generated by ejecting fluid through the nozzle; and
a deformable mechanism, comprising a first piezoelectric layer, a second piezoelectric layer, a first flexible member, and a second flexible member disposed on the substrate, wherein the first and second flexible members define parts of the channel, and when an electrical field is applied to at least one of the first piezoelectric layer or the second piezoelectric layer, at least one of the first flexible member or the second flexible member is deformed, to alter profile of the channel.

12. The microinjector as claimed in claim 11, wherein the first flexible member connects the substrate and the first piezoelectric layer, and the second flexible member connects the first and second piezoelectric layers.

13. The microinjector as claimed in claim 12, wherein the first piezoelectric layer comprises a first piezoelectric portion and a second piezoelectric portion, and the first flexible member comprises a first flexible portion and a second flexible portion, respectively connecting the first and second piezoelectric layers;
wherein the nozzle is narrowed when the first and second piezoelectric portions expand, and the channel is deflected when the first piezoelectric portion expands and the second piezoelectric portion contracts.

14. The microinjector as claimed in claim 13, wherein the second piezoelectric layer comprises a third piezoelectric portion and a fourth piezoelectric portion with the nozzle formed therebetweeen;
wherein the nozzle is narrowed when the third and fourth piezoelectric portions expand, and the nozzle is broadened when the third and fourth piezoelectric portions contract.

15. The microinjector as claimed in claim 14, wherein the second flexible member comprises a third flexible portion connecting the first and third piezoelectric portions, and a fourth flexible portion connecting the second and fourth piezoelectric portions;
wherein the channel is deflected with respect to the first axis when the third piezoelectric portion expands and the fourth piezoelectric portion contracts, to alter ejection direction of droplets.

16. The microinjector as claimed in claim 11, wherein the first piezoelectric layer is substantially parallel to a second axis, perpendicular to the first axis, and the nozzle is shifted along the second axis when the channel is deflected with respect to the first axis.

17. The microinjector as claimed in claim 11, wherein the first piezoelectric layer is substantially perpendicular to the first axis and the electrical field.

18. The microinjector as claimed in claim 11, wherein the first piezoelectric layer is embedded in the first flexible member.

19. The microinjector as claimed in claim 11, wherein the first piezoelectric layer comprises lead zirconate titanate (PZT).

20. The microinjector as claimed in claim 11, wherein the flexible member comprises polymer.
